(19) United States
(12) Patent Application Publication
(10) Pub. No.: US 2012/0270135 A1
(43) Pub. Date: Oct. 25, 2012

(54) CATALYST, METHOD FOR PRODUCING THE SAME, AND USE THEREOF

(75) Inventor: Tadatoshi KUROZUMI, Chiba-shi (JP)

(73) Assignee: SHOWA DENKO K.K., Tokyo (JP)

(21) Appl. No.: 13/091,648

(22) Filed: Apr. 21, 2011

(51) Int. Cl. H01M 4/90; H01B 1/02; H01M 8/10; B01J 31/12

(52) U.S. Cl. 429/482; 502/161; 252/519.2; 429/531

(57) ABSTRACT

Provided is a catalyst having high durability with resistance to corrosion in an acidic electrolyte or at high potential and high oxygen reduction activity. The catalyst is a metal oxycarbonitride containing at least one group III transition metal compound and at least one group IV or V transition metal oxide having a crystallite size of 1 to 100 nm. The group III transition metal compound may be a compound of at least one selected from the group consisting of scandium, yttrium, lanthanum, cerium, samarium, dysprosium, and holmium. The group IV or V transition metal oxide may be an oxide of at least one selected from the group consisting of titanium, zirconium, tantalum, and niobium.

### BACKGROUND OF THE INVENTION

1. Field of the Invention

The present invention relates to catalysts, methods for producing catalysts, and uses of catalysts.

2. Description of the Related Art

Fuel cells are divided into various types according to the type of electrolyte and the type of electrode, including alkaline fuel cells, phosphoric acid fuel cells, molten carbonate fuel cells, solid electrolyte fuel cells, and polymer electrolyte fuel cells. Among others, polymer electrolyte fuel cells, which are operable at low temperatures (about −40° C.) to about 120° C., have attracted attention and have recently been developed and put into practical use as clean power sources for automobiles. Possible uses of polymer electrolyte fuel cells include power sources for vehicles and stationary power supplies. Such uses, however, demand long-term durability.

A polymer electrolyte fuel cell includes a solid polymer electrolyte held between an anode and a cathode. The anode is supplied with fuel, whereas the cathode is supplied with oxygen or air. This type of fuel cell generates electricity by reducing oxygen in the cathode. The fuel used is typically hydrogen or methanol.

In the related art, catalyst-containing layers (hereinafter also referred to as “fuel cell catalyst layers”) are disposed on the surfaces of the cathode (air electrode) and anode (fuel electrode) of the fuel cell for higher reaction rate and energy conversion efficiency.

The catalyst used is typically a noble metal. Among noble metals, platinum has been mainly used for its stability at high potential as well as its high activity. However, platinum is expensive and not abundant, and accordingly there is a demand for the development of alternative catalysts.

Another problem is that noble metals used for the surface of the cathode are inappropriate for uses requiring long-term durability because they may dissolve in an acidic atmosphere. Accordingly, there is a strong demand for the development of a catalyst having high durability with resistance to corrosion in acidic atmospheres and high oxygen reduction activity.

Recently, materials containing nonmetals such as carbon, nitrogen, and boron have attracted attention as alternatives to platinum. These nonmetal-containing materials are less expensive and more abundant than noble metals such as platinum.

S. Doi, A. Ishihara, S. Mitsushima, N. Kamiya, and K. Ota, Journal of The Electrochemical Society, 154 (3) B362-B369 (2007) has reported that a zirconium-based compound represented by the formula ZrOₓN has oxygen reduction activity.

As an alternative to platinum, patent literature JP 2007-31781 A discloses an oxygen reduction electrode material containing a nitride of one or more elements selected from Groups 4, 5 and 14 in the long periodic table.

These nonmetal-containing materials, however, have a problem in that they have no oxygen reduction activity sufficient for use as practical catalysts.

Patent literature JP 2003-342058 A, on the other hand, discloses an oxycarbonitride produced by mixing a carbide, an oxide, and a nitride and heating the mixture in a vacuum or an inert or nonoxidizing atmosphere at 500° C. to 1,500° C.

The oxycarbonitride disclosed in the above publication, however, is a material for thin-film magnetic head ceramic substrates and is not discussed for use as a catalyst.

Platinum is useful not only as a catalyst for fuel cells, but also as a catalyst for exhaust gas treatment or organic synthesis. Because platinum is expensive and not abundant, the development of an alternative catalyst is also demanded for such uses.

### BRIEF SUMMARY OF THE INVENTION

In light of such problems of the related art, an object of the present invention is to provide a catalyst having high durability with resistance to corrosion in an acidic electrolyte or at high potential and high oxygen reduction activity.

As a result of intensive research for solving the above problems of the related art, the inventors have found that a group IV or V metal oxycarbonitride mixture containing at least one group III transition metal compound and at least one group IV or V transition metal oxide having a crystallite size of 1 to 100 nm has high durability with resistance to corrosion in an acidic electrolyte or at high potential and high oxygen reduction activity, thus completing the present invention.

The present invention is concerned with the following (1) to (11).

(1) A catalyst comprising a group IV or V transition metal oxycarbonitride mixture comprising at least one group III transition metal compound and at least one group IV or V transition metal oxide having a crystallite size of 1 to 100 nm.

(2) The catalyst as described in (1) above, wherein the group III transition metal compound is a compound of at least one element selected from the group consisting of scandium, yttrium, lanthanum, cerium, samarium, dysprosium, and holmium.

(3) The catalyst as described in (1) above, wherein the group IV or V transition metal oxide is an oxide of at least one element selected from the group consisting of titanium, zirconium, tantalum, and niobium.

(4) The catalyst as described in any one of (1) to (3) above, which is a catalyst for a fuel cell.

(5) A method for producing the catalyst as described in any one of (1) to (4) above, which is a metal oxycarbonitride mixture catalyst, comprising:

a step of producing a metal carbonitride mixture containing at least one group III transition metal compound and at least one group IV or V transition metal oxide; and

a step of heating the metal carbonitride mixture in an oxygen-containing gas to produce a metal oxycarbonitride mixture.

(6) A fuel cell catalyst layer comprising the catalyst as described in any one of (1) to (4) above.

(7) The fuel cell catalyst layer, further comprising electron-conducting particles.

(8) An electrode comprising the fuel cell catalyst layer as described in (6) or (7) above and a porous support layer.

(9) A membrane electrode assembly comprising a cathode, an anode, and an electrolyte film disposed between the cathode and the anode, wherein the cathode and/or the anode is the electrode as described in (8) above.

(10) A fuel cell comprising the membrane electrode assembly as described in (9) above.

(11) A polymer electrolyte fuel cell comprising the membrane electrode assembly as described in (10) above.

The catalyst according to the present invention is stable without corrosion in an acidic electrolyte or at high potential, has high oxygen reduction activity, and is less expensive than platinum. Accordingly, a fuel cell including the catalyst is relatively inexpensive and has superior performance.

### BRIEF DESCRIPTION OF THE DRAWINGS

FIG. 1 shows the powder X-ray diffraction spectrum of a catalyst (1).

FIG. 2 shows the current-potential curve of an electrode (1).

FIG. 3 shows the powder X-ray diffraction spectrum of a catalyst (2).

FIG. 4 shows the current-potential curve of an electrode (2).

FIG. 5 shows the powder X-ray diffraction spectrum of a catalyst (3).

FIG. 6 shows the current-potential curve of an electrode (3).

FIG. 7 shows the powder X-ray diffraction spectrum of a catalyst (4).

FIG. 8 shows the current-potential curve of an electrode (4).

FIG. 9 shows the powder X-ray diffraction spectrum of a catalyst (5).

FIG. 10 shows the current-potential curve of an electrode (5).

FIG. 11 shows the powder X-ray diffraction spectrum of a catalyst (6).

FIG. 12 shows the current-potential curve of an electrode (6).

### DETAILED DESCRIPTION OF THE INVENTION

### Catalyst

A catalyst according to the present invention comprises a metal oxycarbonitride mixture containing at least one group III transition metal compound and at least one group IV or V transition metal oxide having a crystallite size of 1 to 100 nm.

The proportions and crystallite sizes of the group III transition metal compound and the group IV or V transition metal oxide in the catalyst according to the present invention can be determined by Rietveld analysis.

Rietveld analysis is known in the related art as a method for determining the crystal structure of a material having different crystal phases. This method will now be described in detail.

Rietveld analysis uses an analytical technique, called pattern fitting, in which an actual diffraction pattern is obtained from an analyte by X-ray diffraction (XRD) and is used to refine various parameters in an approximate calculation formula so that a calculated diffraction pattern based on the approximate calculation formula matches the actual diffraction pattern. After the refinement of the various parameters, some of them can be used to determine the proportions of different crystal phases (such as monoclinic, tetragonal, and cubic crystals) and the sizes (diameters) of the crystallites.

To obtain precise analytical parameters, the diffraction angle 2θ for measurement is preferably 10° to 110°. In addition, the diffraction angle interval for measurement is preferably 0.02° or less. Furthermore, the measurement time is preferably set so that the diffraction intensity at the maximum peak of the resultant X-ray diffraction pattern is 5,000 or more. This Rietveld analysis can be performed using Rietveld analysis software such as RIETAN-2000.

The catalyst according to the present invention contains at least one group III transition metal compound. The group III transition metal element may be either a lanthanide or an actinide.

The group III transition metal element is preferably at least one element selected from the group consisting of scandium, yttrium, lanthanum, cerium, samarium, dysprosium, and holmium.

Although the details remain uncertain, generally, a group III transition metal element easily dissolves into a group IV or V transition metal oxide. The group III transition metal element forms defects in the group IV or V transition metal oxide to inhibit crystal growth of the group IV or V transition metal oxide, thus decreasing the grain size thereof.

A catalyst having a smaller grain size is preferred because it has a larger specific surface area. In addition, defect points presumably act as active points to increase the catalytic activity.

Although the amount of group III transition metal compound added depends on the metal species, it is preferably 0.1 to 20 mole percent of the total amount of transition metal compounds (i.e., group III transition metal compounds and group IV or V transition metal compounds) in the catalyst. If the amount of group III transition metal compound added falls below 0.1 mole percent, the effect thereof may be smaller. On the other hand, if the amount of group III transition metal compound added exceeds 20 mole percent, it may undesirably lower the catalysis of the metal oxycarbonitride mixture.

Whereas the group III transition metal element presumably acts, partially dissolving into the group IV or V transition metal oxide, it may also be detected as a group III transition metal oxide, depending on the type and amount of element added.

In view of resistance to corrosion in an acidic electrolyte or at high potential, at least one group IV or V transition metal is preferably a metal oxycarbonitride. In particular, titanium, zirconium, tantalum, or niobium is preferable.

The term “group IV or V transition metal oxide” refers to an approximately matched compound when refined by Rietveld analysis. In addition, the crystallite size of the group IV or V transition metal oxide determined by Rietveld analysis is 1 to 100 nm, preferably 3 to 80 nm, more preferably 5 to 50 nm. A crystallite size below 1 nm is undesirable because the particles are difficult to handle due to their tendency to aggregate. A crystallite size above 100 nm is undesirable because the catalyst may have low oxygen reduction activity due to its small catalytic area.

The catalyst according to the present invention may be produced by any method.

For example, the catalyst according to the present invention can be produced by a method comprising a step of producing a group IV or V transition metal carbonitride mixture containing at least one group III transition metal compound and at least one group IV or V transition metal oxide, and a step of heating the metal carbonitride mixture in an oxygen-containing gas to produce a metal oxycarbonitride mixture containing the metal oxide having a crystallite size of 1 to 100 nm.

Presumably the smaller particle size the group IV or V transition metal carbonitride mixture containing at least one group III transition metal compound and at least one group IV or V transition metal oxide has, the smaller crystallite size the metal oxide in the metal oxycarbonitride produced by heating the transition metal carbonitride in the oxygen-containing inert gas has.

### Step of Producing Metal Carbonitride

Examples of methods for producing the group IV or V transition metal carbonitride mixture containing at least one group III transition metal compound and at least one group IV or V transition metal oxide include:

(I) a solid-phase method comprising a step of heating, as raw materials, hydrides, oxides, carbides, or nitrides of group III and group IV or V transition metals, that are to constitute the metals in the present invention, optionally with carbon added thereto in a nitrogen atmosphere to produce the metal carbonitride mixture containing at least one group III transition metal and at least one group IV or V transition metal; and

(II) a method comprising a step of producing the metal carbonitride mixture containing at least one group III transition metal and at least one group IV or V transition metal and having a small particle size by a combination that includes a liquid-phase method using a complex as a raw material.

Next, as an example of method (I), a method for producing a group IV or V transition metal carbonitride mixture containing at least one group III transition metal compound and at least one group IV or V transition metal oxide from a metal oxide and carbon as raw materials will be discussed in detail.

The group IV or V transition metal oxide used is not particularly limited. Examples of group IV or V transition metal oxides include zirconium oxides such as ZrO, ZrO₂, and Zr₂O₅ and titanium oxides such as TiO, Ti₃O₄, TiO₂, Ti₃O₅, and TiₙO₂ₙ₋₁ can be used. In particular, ZrO₂ and TiO₂ are preferred because they are inexpensive and easily available.

The group III transition metal oxide used is not particularly limited. Examples of group III transition metal oxides include Sc₂O₃, Y₂O₃, La₂O₃, CeO₂, Sm₂O₃, Dy₂O₃, Ho₂O₃.

Examples of the carbon used as a raw material include carbon black, graphite, activated carbon, carbon nanotubes, carbon nanofibers, carbon nanohorns, and fullerene. A carbon powder having a smaller particle size is preferred because it has a larger specific surface area and therefore a higher reactivity with oxides. For example, carbon black (specific surface area: 100 to 300 m²/g; for example, XC-72 available from Cabot Corporation) is preferably used.

The amount of the group III transition metal oxide added (in mole percent) is typically 0.1 to 20 mole percent based on the amount of the group IV or V transition metal oxide added. In addition, the ratio of the number of moles of carbon to the total number of moles of group III transition metal oxide and group IV or V transition metal oxide is from 1 to 4, preferably from 2 to 3.

The group III transition metal oxide, the group IV or V transition metal oxide, and carbon are sufficiently mixed and then heated in a nitrogen atmosphere.

They are typically heated in an electric furnace. The heating temperature is 1,200° C. to 2,200° C., preferably 1,400° C. to 1,700° C. If the heating temperature falls below 1,200° C., a metal carbonitride mixture containing at least one group IV or V transition metal is not produced. At a lower firing temperature, a metal carbonitride mixture containing at least one group IV or V transition metal and having a smaller particle size is produced, although the raw material is more likely to remain. If the heating temperature exceeds 2,200° C., the metal carbonitride mixture according to the present invention containing at least one group IV or V transition metal oxide and having a crystallite size of 1 to 100 nm is not produced because the particles become large as a result of sintering. Depending on the metal species, a metal carbonitride containing at least one group IV or V transition metal, having a small particle size, and containing little residue of the raw material is formed at 1,400° C. to 1,700° C.

### Step of Producing Metal Oxycarbonitride

Next, the step of heating the metal carbonitride mixture produced by the above method in an oxygen-containing gas to produce the metal oxycarbonitride mixture will be described.

Diluting oxygen with an inert gas allows control for uniform oxidation. Examples of the inert gas include nitrogen, helium gas, neon gas, argon gas, krypton gas, xenon gas, and radon gas. In particular, nitrogen and argon gas are preferred in that they are relatively easily available.

In addition, the inert gas may be mixed with hydrogen. The hydrogen concentration is preferably 0.0001% to 10% by volume, more preferably 0.05% to 5% by volume. A hydrogen concentration within this range is preferred in that a homogeneous oxycarbonitride is produced. A hydrogen concentration below 0.0001% by volume is undesirable because it is less effective. On the other hand, a hydrogen concentration above 10% by volume is undesirable because the oxidation may be insufficient.

The oxygen concentration in this step is preferably 0.0001% to 10% by volume, more preferably 0.03% to 3% by volume, depending on the heating time and the heating temperature. An oxygen concentration within this range is preferred in that a homogeneous oxycarbonitride is produced.

If the oxygen concentration falls below 0.0001% by volume, the raw material tends to remain unoxidized. If the oxygen concentration exceeds 10% by volume, the oxidation tends to proceed excessively.

The heating temperature in this step is typically 400° C. to 1,400° C., preferably 600° C. to 1,200° C. A heating temperature within this range is preferred in that a homogeneous oxycarbonitride is produced. If the heating temperature falls below 400° C., the oxidation does not proceed. If the heating temperature exceeds 1,400° C., the oxidation may proceed at an uncontrollably high rate.

Examples of heating methods for this step include a standing method, a stirring method, a dropping method, and a powder capturing method.

The dropping method is a method for heating the raw material, namely, the metal carbonitride mixture, by dropping it into a crucible, serving as a heating region, of an induction furnace heated to and maintained at a predetermined heating temperature while allowing an inert gas containing a trace amount of oxygen to flow through the furnace. This method is preferred in that it minimizes aggregation and growth of the particles of the metal oxycarbonitride mixture.

The powder capturing method is a method for heating the metal carbonitride mixture by suspending it in the form of droplets in an inert gas atmosphere containing a trace amount of oxygen and trapping it in a vertical tube furnace maintained at a predetermined heating temperature.

As the catalyst according to the present invention, the metal oxycarbonitride mixture produced by the above method may be directly used or may be further pulverized into a finer powder before use.

Examples of methods for pulverizing the metal oxycarbonitride include those using a roller mill, a ball mill, a medium stirring mill, a jet mill, a mortar, and a crushing tank. The use of a jet mill is preferred in that it can pulverize the metal oxycarbonitride into finer particles, whereas the use of a mortar is preferred in that it is suitable for low-volume processing.

### Use

The catalyst according to the present invention can be used as an alternative to platinum catalysts.

For example, the catalyst according to the present invention can be used as a catalyst for fuel cells, exhaust gas treatment, or organic synthesis.

A fuel cell catalyst layer according to the present invention comprises the above catalyst.

The fuel cell catalyst layer according to the present invention can be used either as an anode catalyst layer or a cathode catalyst layer. The fuel cell catalyst layer according to the present invention is useful as a catalyst layer provided on a cathode of a fuel cell (cathode catalyst layer) because it comprises a catalyst having high oxygen reduction activity and resistance to corrosion in an acidic electrolyte at high potential. In particular, the fuel cell catalyst layer according to the present invention is preferably used as a catalyst provided on a cathode of a membrane electrode assembly in a polymer electrolyte fuel cell.

The fuel cell catalyst layer according to the present invention preferably further contains electron-conducting particles. If the fuel cell catalyst layer comprising the above catalyst further contains electron-conducting particles, they allow more reduction current to flow. The electron-conducting particles allow more reduction current to flow probably because they establish electrical contacts with the catalysts for inducing electrochemical reaction.

The electron-conducting particles are usually used as a catalyst carrier.

Examples of electron-conducting particles include carbon, conductive polymers, conductive ceramics, metals, and conductive inorganic oxides such as tungsten oxide and iridium oxide, which can be used alone or in combination. In particular, carbon is preferably used alone or as a mixture with other electron-conducting particles because carbon has large specific surface area. That is, the fuel cell catalyst layer preferably contains the above catalyst and carbon.

Examples of carbon include carbon black, graphite, activated carbon, carbon nanotubes, carbon nanofibers, carbon nanohorns, and fullerene. The particle size of carbon is preferably 10 to 1,000 nm, more preferably 10 to 100 nm. If the particle size is excessively small, an electron-conducting path tends not to be easily formed. On the other hand, if the particle size is excessively large, the gas diffusibility of the fuel cell catalyst layer and the availability of the catalyst tend to decrease.

If the electron-conducting particles are carbon, the weight ratio of the catalyst to carbon (catalyst:electron-conducting particles) is preferably 4:1 to 1,000:1.

Examples of the conductive polymers include, but not limited to, polyacetylene, poly(p-phenylene), polyaniline, polyalkylaniline, polypyrrole, polythiophene, polyindole, poly(1,5-diaminoanthraquinone), polyaminodiphenyl, poly(o-phenylenediamine), poly(quinolinium) salts, polypyridine, polyquinoxaline, and polyphenylquinoxaline. Of these, polypyrrole, polyaniline, and polythiophene are preferable, and polypyrrole is more preferable.

A common polymer electrolyte used in fuel cell catalyst layers may be used without limitation. Examples of the polymer electrolytes include perfluorocarbon polymers having a sulfonic acid group (for example, NAFION (5% NAFION solution (DE521) available from Du Pont), hydrocarbon polymers having a sulfonic acid group, polymers doped with an inorganic acid such as phosphoric acid, organic-inorganic hybrid polymers partially substituted with a proton-conducting group, and proton conductors composed of a polymer matrix impregnated with a phosphoric or sulfuric acid solution. Of these, NAFION (5% NAFION solution (DE521) available from Du Pont) is preferred.

Examples of methods for dispersing the catalyst over the electron-conducting particles, serving as a carrier, include jet dispersion and in-liquid dispersion. The in-liquid dispersion is preferred because the fuel cell catalyst layer may be formed using a dispersion of the catalyst and the electron-conducting particles in a solvent. Examples of methods for the in-liquid dispersion include those using an orifice-choked flow, a rotating shear flow, and ultrasound. The solvent used for the in-liquid dispersion may be any solvent in which the catalyst and the electron-conducting particles can be dispersed without being eroded, and is typically, for example, a volatile liquid organic solvent or water.

In addition, the catalyst may be dispersed over the electron-conducting particles together with the electrolyte and a dispersant.

The fuel cell catalyst layer can be formed by any method, for example, by coating an electrolyte film or gas diffusion layer, described later, with a suspension containing the catalyst, the electron-conducting particles, and the electrolyte. Examples of the coating method include dipping, screen printing, roller coating, and spraying. In another embodiment, a suspension containing the catalyst, the electron conductive particles and the electrolyte is applied or filtered on a substrate to form a fuel cell catalyst layer, and the catalyst layer is transferred to an electrolyte membrane.

An electrode according to the present invention comprises the above fuel cell catalyst layer and a porous support layer.

The electrode according to the present invention can be used either as a cathode or as an anode. The electrode according to the present invention is more effective for use as a cathode because it has high durability and high catalytic activity.

The porous support layer is a layer that diffuses gas (hereinafter also referred to as “gas diffusion layer”). The gas diffusion layer may be any layer that has electron conductivity, high gas diffusibility, and high corrosion resistance, and is typically a carbonaceous porous material such as carbon paper or carbon cloth, or a stainless steel or an aluminum foil covered with a corrosion-resistant material for weight reduction.

A membrane electrode assembly according to the present invention comprises a cathode, an anode, and an electrolyte film disposed between the cathode and the anode, and the cathode and/or the anode is the above electrode.

The electrolyte film used is typically, for example, a perfluorosulfonic acid electrolyte film or a hydrocarbon electrolyte film. A microporous polymer film impregnated with a liquid electrolyte or a porous film filled with a polymer electrolyte can also be used.

A fuel cell according to the present invention comprises the above membrane electrode assembly.

The electrode reactions in the fuel cell occur at three-phase interfaces (between the electrolyte, the electrode catalyst, and the reaction gases). Fuel cells are divided into several types according to, for example, the type of electrolyte used, including molten carbonate fuel cells (MCFC), phosphoric acid fuel cells (PAFC), solid oxide fuel cells (SOFC), and polymer electrolyte fuel cells (PEFC). In particular, the membrane electrode assembly according to the present invention is preferably used for polymer electrolyte fuel cells.

### EXAMPLES

The present invention will now be described in greater detail with reference to the examples below, although the invention is not limited thereto.

### Example 1

### 1. Preparation of Catalyst

First, 0.17 g (1 mmol) of cerium dioxide, 7.92 g (99 mmol) of titanium oxide, and 3 g (250 mmol) of carbon black (Vulcan 72, available from Cabot Corporation) were sufficiently mixed with a ball mill. The mixture was heated at 1,500° C. in a nitrogen atmosphere for three hours. The product was sufficiently pulverized with a ball mill to yield 7.2 g of a carbonitride mixture.

Then, 300 mg of the resultant titanium carbonitride mixture was heated in a tube furnace at 1,000° C. in a nitrogen atmosphere containing 1.5% by volume of oxygen gas and 4% by volume of hydrogen for three hours. The resultant titanium oxycarbonitride mixture (hereinafter also referred to as “catalyst (1)”) was sufficiently pulverized to yield 270 mg of catalyst (1).

The X-ray diffraction spectrum was measured using X'Pert PRO MPD, where the voltage was 45 V, the current was 40 mA, the diffraction angle 2θ for measurement was 10° to 110°, and the diffraction angle interval for measurement was 0.016711°.

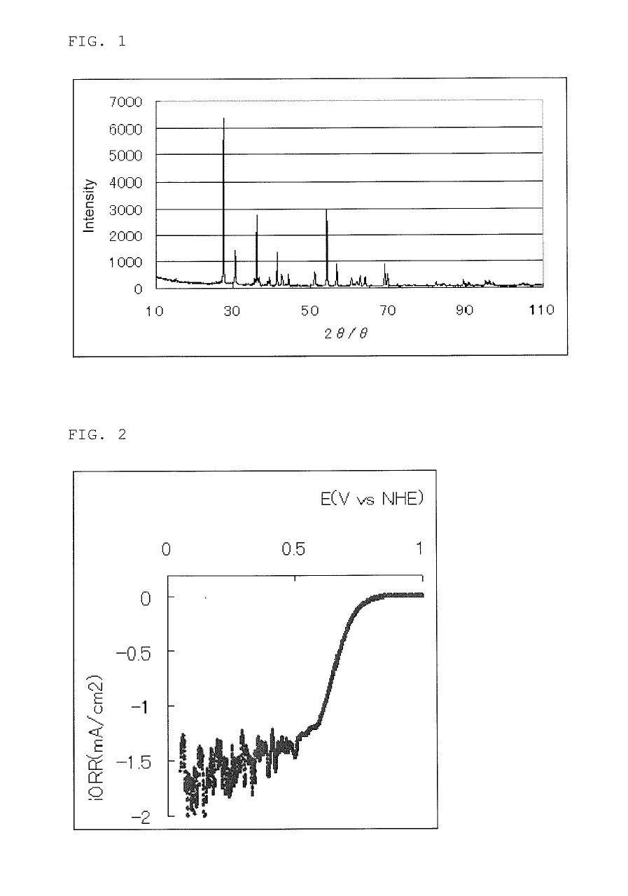

FIG. 1 shows the powder X-ray diffraction spectrum of catalyst (1).

The crystallite size of titanium oxide in the titanium oxycarbonitride mixture was determined from the measured diffraction pattern using the Rietveld analysis software “JADE” available from Rigaku Corporation. The results are shown in Table 1.

TABLE 1

| | Crystallite size (nm) |
|---|---|
| Example 1 | 85 |
| Example 2 | 85 |
| Comparative Example 1 | >100 |

### 2. Production of Fuel Cell Electrode

The oxygen reduction activity was measured as follows. First, 0.095 g of catalyst (1) and 0.005 g of carbon black (XC-72, available from Cabot Corporation) were put into 10 g of a solution containing isopropyl alcohol and pure water at a weight ratio (isopropyl alcohol:pure water) of 2:1 and were mixed by stirring and suspending them by ultrasonic treatment. Then, 30 μL of the mixture was applied to a glassy carbon electrode (available from Tokai Carbon Co., Ltd.; diameter: 5.2 mm) and was dried at 120° C. for one hour. In addition, 10 μL of NAFION (5% NAFION solution (DE521) available from Du Pont) diluted ten times with pure water was applied and was dried at 120° C. for one hour to produce fuel cell electrode (1).

### 3. Evaluation of Oxygen Reduction Activity

Fuel cell electrode (1) thus produced was evaluated for catalytic activity (oxygen reduction activity) by the following method.

First, fuel cell electrode (1) was polarized at 30° C. and a potential scan rate of 5 mV/s in a 0.5 mol/dm³ sulfuric acid solution under an oxygen atmosphere and a nitrogen atmosphere to measure the current-potential curve, where the reference electrode used was a reversible hydrogen electrode in a sulfuric acid solution having the same concentration.

From the measurement results, the difference between the reduction current under the oxygen atmosphere and the reduction current under the nitrogen atmosphere was determined.

FIG. 2 shows the oxygen reduction current-oxygen reduction potential curve (hereinafter referred to as “current-potential curve”) obtained by the above measurement.

Table 2 shows the current density at 0.7 V (vs. NHE). The larger is the oxygen reduction current, the higher is the catalytic activity (oxygen reduction activity) of the fuel cell electrode (1).

TABLE 2

| | Current density at 0.7 V |
|---|---|
| | (mA/cm²) |
| Example 1 | 0.34 |
| Example 2 | 0.20 |
| Comparative Example 1 | 0.01 |

### Example 2

### 1. Preparation of Catalyst

First, 0.81 g (2.5 mmol) of diyttrium trioxide, 7.6 g (95 mmol) of titanium oxide, and 3 g (250 mmol) of carbon black (Vulcan 72, available from Cabot Corporation) were sufficiently mixed with a ball mill. The mixture was heated at 1,500° C. in a nitrogen atmosphere for three hours. The product was sufficiently pulverized with a ball mill to yield 7.4 g of a carbonitride mixture.

Then, 300 mg of the resultant titanium carbonitride mixture was heated in a tube furnace at 1,000° C. in a nitrogen atmosphere containing 1.5% by volume of oxygen gas and 4% by volume of hydrogen for three hours. The resultant titanium oxycarbonitride mixture (hereinafter also referred to as “catalyst (2)”) was sufficiently pulverized to yield 275 mg of catalyst (2).

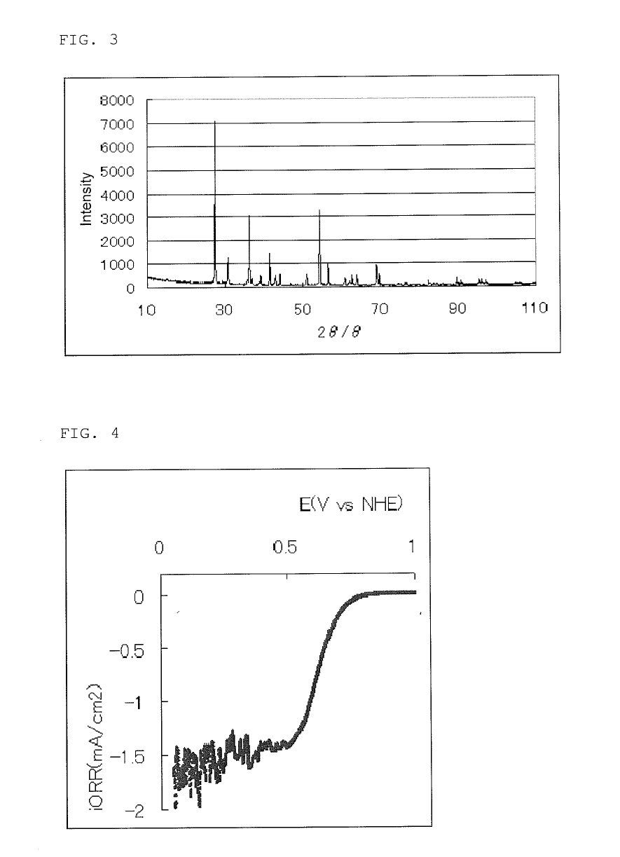

The X-ray diffraction spectrum was measured in the same manner as in Example 1. FIG. 3 shows the powder X-ray diffraction spectrum of catalyst (2).

The crystallite size of titanium oxide in the titanium oxycarbonitride mixture was determined by Rietveld analysis in the same manner as in Example 1. The results are shown in Table 1.

### 2. Production of Fuel Cell Electrode

Fuel cell electrode (2) was produced in the same manner as in Example 1 except that catalyst (2) was used.

### 3. Evaluation of Oxygen Reduction Activity

Fuel cell electrode (2) was evaluated for catalytic activity (oxygen reduction activity) in the same manner as in Example 1.

FIG. 4 shows the current-potential curve obtained by the above measurement.

Table 2 shows the current density at 0.7 V (vs. NHE).

### Example 3

### 1. Preparation of Catalyst

First, 0.09 g (0.5 mmol) of cerium dioxide, 12.3 g (99.5 mmol) of zirconium oxide, and 3 g (250 mmol) of carbon black (Vulcan 72, available from Cabot Corporation) were sufficiently mixed with a ball mill. The mixture was heated at 1,700° C. in a nitrogen atmosphere for three hours. The product was sufficiently pulverized with a ball mill to yield 11.3 g of a zirconium carbonitride mixture.

Then, 300 mg of the resultant zirconium carbonitride mixture was heated in a tube furnace at 1,000° C. in a nitrogen atmosphere containing 0.75% by volume of oxygen gas and 4% by volume of hydrogen for three hours. The resultant zirconium oxycarbonitride mixture (hereinafter also referred to as “catalyst (3)”) was sufficiently pulverized to yield 280 mg of catalyst (3).

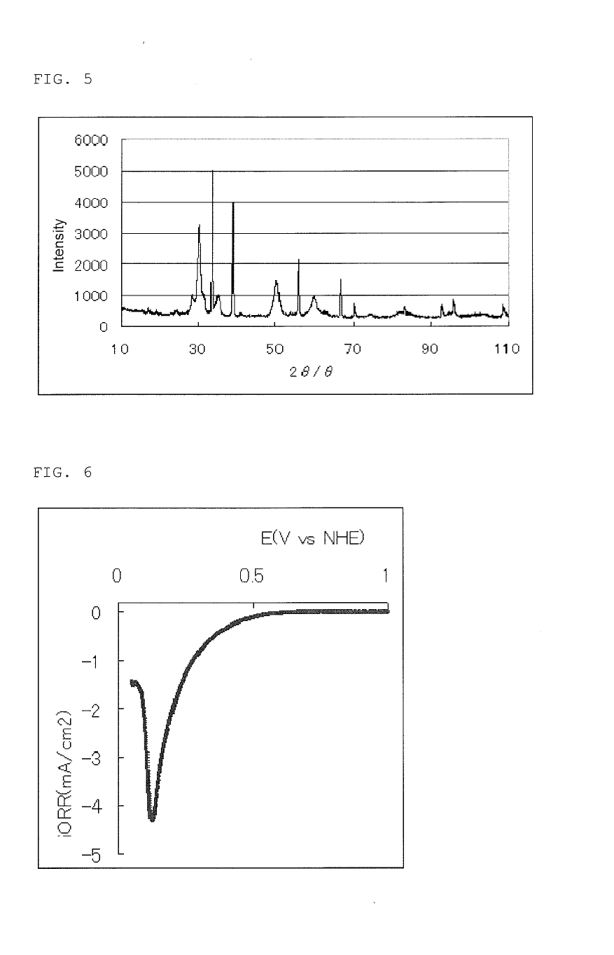

The X-ray diffraction spectrum was measured in the same manner as in Example 1. FIG. 5 shows the powder X-ray diffraction spectrum of catalyst (3).

The crystallite sizes of monoclinic crystals and tetragonal crystals of zirconium oxide in the zirconium oxycarbonitride mixture were determined by Rietveld analysis in the same manner as in Example 1. The results are shown in Table 3.

TABLE 3

| | Crystallite size of | Crystallite size of |
|---|---|---|
| | monoclinic crystals | tetragonal crystals |
| | (nm) | (nm) |
| Example 3 | 7 | 9 |
| Example 4 | 4 | 9 |
| Comparative Example 2 | 21 | 14 |

### 2. Production of Fuel Cell Electrode

Fuel cell electrode (3) was produced in the same manner as in Example 1 except that catalyst (3) was used.

### 3. Evaluation of Oxygen Reduction Activity

Fuel cell electrode (3) was evaluated for catalytic activity (oxygen reduction activity) in the same manner as in Example 1.

FIG. 6 shows the current-potential curve obtained by the above measurement.

Table 4 shows the current density at 0.5 V (vs. NHE).

TABLE 4

| | Current density at 0.5 V |
|---|---|
| | (mA/cm²) |
| Example 3 | 0.11 |
| Example 4 | 0.17 |
| Comparative Example 2 | 0.01 |

### Example 4

### 1. Preparation of Catalyst

First, 1.61 g (5 mmol) of diyttrium trioxide, 7.6 g (90 mmol) of zirconium oxide, and 3 g (250 mmol) of carbon black (Vulcan 72, available from Cabot Corporation) were sufficiently mixed with a ball mill. The mixture was heated at 1,700° C. in a nitrogen atmosphere for three hours. The product was sufficiently pulverized with a ball mill to yield 11.6 g of a zirconium carbonitride mixture.

Then, 300 mg of the resultant zirconium carbonitride mixture was heated in a tube furnace at 1,000° C. in a nitrogen atmosphere containing 0.75% by volume of oxygen gas and 4% by volume of hydrogen for three hours. The resultant zirconium oxycarbonitride mixture (hereinafter also referred to as “catalyst (4)”) was sufficiently pulverized to yield 275 mg of catalyst (4).

The X-ray diffraction spectrum was measured in the same manner as in Example 1. FIG. 7 shows the powder X-ray diffraction spectrum of catalyst (4).

The crystallite sizes of monoclinic crystals and tetragonal crystals of zirconium oxide in the zirconium oxycarbonitride mixture were determined by Rietveld analysis in the same manner as in Example 1. The results are shown in Table 3.

### 2. Production of Fuel Cell Electrode

Fuel cell electrode (4) was produced in the same manner as in Example 1 except that catalyst (4) was used.

### 3. Evaluation of Oxygen Reduction Activity

Fuel cell electrode (4) was evaluated for catalytic activity (oxygen reduction activity) in the same manner as in Example 1.

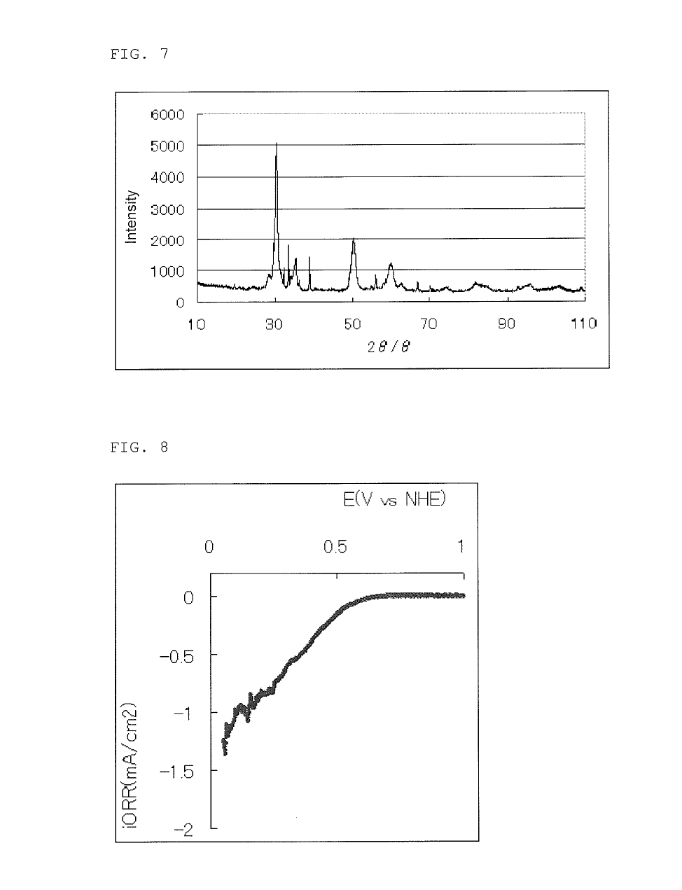

FIG. 8 shows the current-potential curve obtained by the above measurement.

Table 4 shows the current density at 0.5 V (vs. NHE).

### Comparative Example 1

### 1. Preparation of Catalyst

First, 8.0 g (100 mmol) of titanium oxide, and 3 g (250 mmol) of carbon black (Vulcan 72, available from Cabot Corporation) were sufficiently mixed with a ball mill. The mixture was heated at 1,500° C. in a nitrogen atmosphere for three hours. The product was sufficiently pulverized with a ball mill to yield 7.2 g of a titanium carbonitride mixture.

Then, 300 mg of the resultant titanium carbonitride mixture was heated in a tube furnace at 1,000° C. in a nitrogen atmosphere containing 1.5% by volume of oxygen gas and 4% by volume of hydrogen for three hours. The resultant titanium oxycarbonitride mixture (hereinafter also referred to as “catalyst (5)”) was sufficiently pulverized to yield 275 mg of catalyst (2).

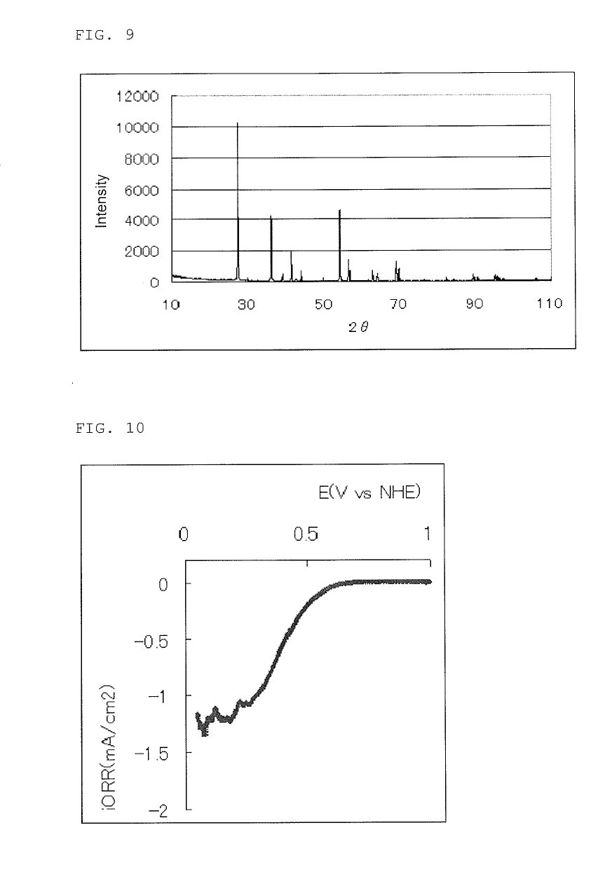

The X-ray diffraction spectrum was measured in the same manner as in Example 1. FIG. 9 shows the powder X-ray diffraction spectrum of catalyst (5).

The crystallite size of titanium oxide in the titanium oxycarbonitride mixture was determined by Rietveld analysis in the same manner as in Example 1. The results are shown in Table 1.

### 2. Production of Fuel Cell Electrode

Fuel cell electrode (5) was produced in the same manner as in Example 1 except that catalyst (5) was used.

### 3. Evaluation of Oxygen Reduction Activity

Fuel cell electrode (5) was evaluated for catalytic activity (oxygen reduction activity) in the same manner as in Example 1.

FIG. 10 shows the current-potential curve obtained by the above measurement.

Table 2 shows the current density at 0.7 V (vs. NHE).

### Comparative Example 2

### 1. Preparation of Catalyst

First, 12.3 g (100 mmol) of zirconium oxide and 3 g (250 mmol) of carbon black (Vulcan 72, available from Cabot Corporation) were sufficiently mixed with a ball mill. The mixture was heated at 1,500° C. in a nitrogen atmosphere for three hours. The product was sufficiently pulverized with a ball mill to yield 11.9 g of a zirconium carbonitride mixture.

Then, 300 mg of the resultant zirconium carbonitride mixture was heated in a tube furnace at 1,000° C. in a nitrogen atmosphere containing 0.75% by volume of oxygen gas and 4% by volume of hydrogen for three hours. The resultant zirconium oxycarbonitride mixture (hereinafter also referred to as “catalyst (6)”) was sufficiently pulverized to yield 275 mg of catalyst (6).

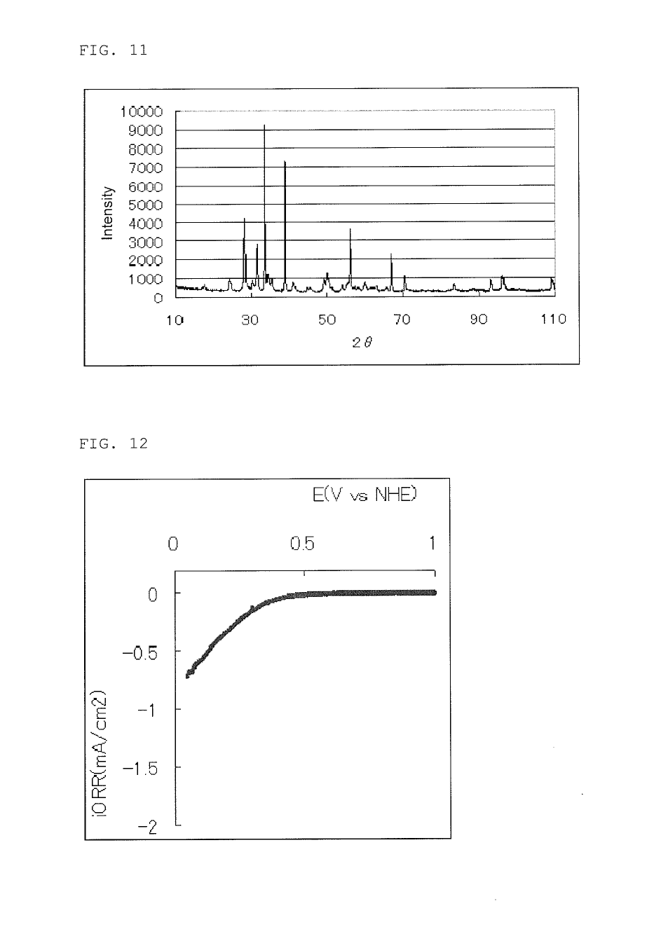

The X-ray diffraction spectrum was measured in the same manner as in Example 1. FIG. 11 shows the powder X-ray diffraction spectrum of catalyst (6).

The crystallite sizes of monoclinic crystals and tetragonal crystals of zirconium oxide in the zirconium oxycarbonitride mixture were determined by Rietveld analysis in the same manner as in Example 1. The results are shown in Table 3.

### 2. Production of Fuel Cell Electrode

Fuel cell electrode (6) was produced in the same manner as in Example 1 except that catalyst (6) was used.

### 3. Evaluation of Oxygen Reduction Activity

Fuel cell electrode (5) was evaluated for catalytic activity (oxygen reduction activity) in the same manner as in Example 1.

FIG. 12 shows the current-potential curve obtained by the above measurement.

Table 4 shows the current density at 0.5 V (vs. NHE).

A catalyst produced by the method according to the present invention has high durability with resistance to corrosion in an acidic electrolyte or at high potential and high oxygen reduction activity and can therefore be used for fuel cell catalyst layers, electrodes, electrode assemblies, and fuel cells.

What is claimed is:

1. A catalyst comprising a group IV or V transition metal oxycarbonitride mixture containing at least one group III transition metal compound and at least one group IV or V transition metal oxide having a crystallite size of 1 to 100 nm, the said group III transition metal is at least one selected from the group consisting of yttrium and cerium, and the said group IV or V transition metal is at least one selected from the group consisting of titanium and niobium.

2. The catalyst according to claim 1, which is a fuel cell catalyst.

3. A method for producing the catalyst according to claim 1, which is a metal oxycarbonitride mixture catalyst, comprising:
a step of producing a metal carbonitride mixture containing at least one group III transition metal compound and at least one group IV or V transition metal oxide, the said group III transition metal being at least one element selected from the group consisting of yttrium and cerium, and the said group IV or V transition metal being at least one element selected from the group consisting of titanium and niobium; and
a step of heating the metal carbonitride mixture in an oxygen-containing gas to produce a metal oxycarbonitride mixture.

4. A fuel cell catalyst layer comprising the catalyst according to claim 1.

5. The fuel cell catalyst layer according to claim 4, further comprising electron-conducting particles.

6. An electrode comprising the fuel cell catalyst layer according to claim 4 and a porous support layer.

7. A membrane electrode assembly comprising:
a cathode;
an anode; and
an electrolyte film disposed between the cathode and the anode, the said cathode and/or the anode being the electrode according to claim 6.

8. A fuel cell comprising the membrane electrode assembly according to claim 7.

9. A polymer electrolyte fuel cell comprising the membrane electrode assembly according to claim 7.
